(19) United States
(12) Patent Application Publication
(10) Pub. No.: US 2026/0034429 A1
(43) Pub. Date: Feb. 5, 2026

(54) PIN FALL DETECTING SYSTEM

(71) Applicant: QUBICAAMF WORLDWIDE, LLC, Mechanicsville, VA (US)

(72) Inventors: Roberto Vaioli, Ozzano dell’Emilia (IT); Joel Forbes, Richmond, VA (US)

(21) Appl. No.: 19/013,568

(22) Filed: Jan. 8, 2025

Related U.S. Application Data
(60) Provisional application No. 63/678,287, filed on Aug. 1, 2024.

(51) Int. Cl. A63D 5/04; A63D 5/08; G06V 20/50

(52) U.S. Cl. CPC A63D 5/04; A63D 5/08; G06V 20/50

(57) ABSTRACT

The present disclosure relates to a string bowling machine and, more particularly, to a string bowling machine provided with a hybrid pin fall detection mechanism for detecting fallen pins after ball impact. The pin fall detection system includes: a vision system positioned to detect a fallen pin; and a machine pin-string sliding detection system to detect movement of individual strings attached to individual pins and which is used in tandem with the vision system to accurately determine which pins of the individual pins have fallen after a throw of a bowling ball.

### FIELD OF INVENTION

The present disclosure relates to a string bowling machine and, more particularly, to a string bowling machine provided with a hybrid pin fall detection mechanism for detecting fallen pins after ball impact.

### BACKGROUND

A way for detecting if a pin has fallen in a string machine is by monitoring each pin's retaining string to determine if it has been pulled/dragged by the falling pin. This kind of pin fall detection aims to establish if a pin has fallen or is still standing by monitoring what happens to the retaining string. The way a string is pulled does not always reflect that the pin is standing or has fallen. Examples for situations where the detector may fail to detect a fallen/standing pin include (but other examples exist):
1. If, after the ball impact, the dynamic of the falling pins ends up pushing another standing pin on the flat gutter (the gutter that is on the side of the pin deck), not making it fall. In this situation, the string might not have been pulled enough to pass the threshold that makes the detector detect that a pin has fallen. But, according to the rules, a pin standing in the gutter is a fallen pin; or
2. If the ball impact makes a pin flying above other pins, it might end up pulling their string. That is, a pin can have a string pulled (by a flying pin) but the pin can be still standing. In this case, the detector might see a pulled string (assuming the pin has fallen) but it is still standing.

A camera may also be used to detect a fallen pin. This pin fall detection has inaccuracies, too. These may be in general, caused by two reasons:
1. A pin hides behind another pin, making it difficult for the camera to determine if the pin is standing on fallen; or
2. The pin's illumination might be very variable and is affected by other environment illumination, spotlights, flashes/strobe lights located somewhere in the bowling center for entertaining the customers.

### SUMMARY

In an aspect of the disclosure, a pin fall detection system comprises: a vision system positioned to detect a fallen pin; and a machine pin-string sliding detection system to detect movement of individual strings attached to individual pins and which is used in tandem with the vision system to accurately determine which pins of the individual pins have fallen after a throw of a bowling ball.

In an aspect of the disclosure, a system comprises: a vision system positioned to view a plurality of pins at an end of a bowling lane; a machine pin-string sliding detection system configured to detect movement of individual strings attached to individual pins; and a control system that is in communication with the vision system and the machine pin-string sliding detection system, the control system receiving data from the vision system and the machine pin-string sliding detection system as to which pins of the plurality of pins each of the vision system and the machine pin-string sliding detection system have detected to be fallen and which reconciles the data to determine which pins have fallen.

### BRIEF DESCRIPTION OF THE DRAWINGS

The present disclosure is described in the detailed description which follows, in reference to the noted plurality of drawings by way of non-limiting examples of exemplary embodiments of the present disclosure.

FIGS. 1A-1C show a pinspotter machine with a hybrid pin fall detection system in accordance with aspects of the present disclosure.

FIG. 2 shows a vision system placed between bowling lanes of a bowling center with all pins in their initial position in accordance with aspects of the present disclosure.

FIG. 3 shows a visions system placed above pins, amongst other features, in accordance with aspects of the present disclosure.

FIG. 4 shows a hidden pin scenario, amongst other features, in accordance with aspects of the present disclosure.

FIG. 5 shows a computation algorithm that combines information from the machine pin-string sliding detection system and the information from the vision system, to minimize the scoring mistakes in accordance with aspects of the present disclosure.

FIG. 6 shows a bowling scoring and management system in accordance with aspects of the present disclosure.

FIG. 7 shows a representative computer infrastructure, which can be representative of a bowling scoring and/or management system.

### DETAILED DESCRIPTION

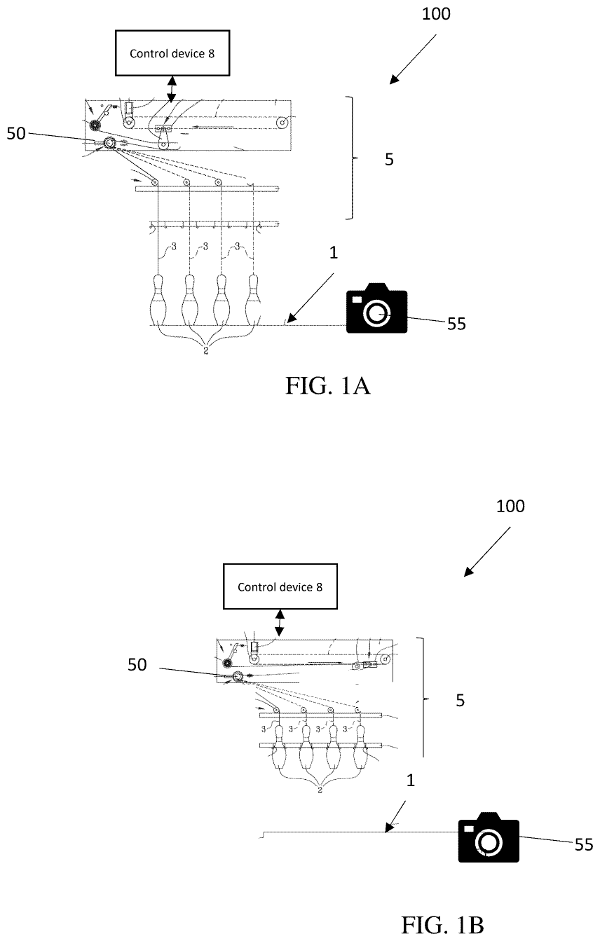

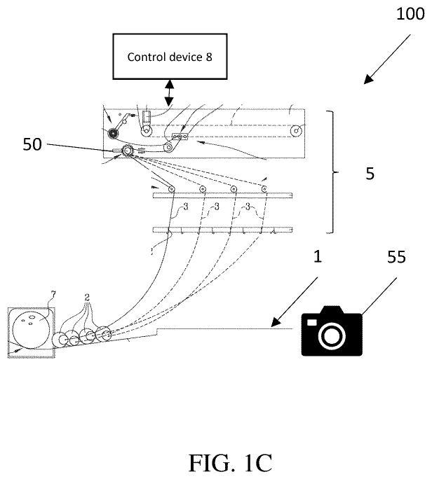

The present disclosure relates to a string bowling machine and, more particularly, to a string bowling machine provided with a hybrid pin fall detection mechanism for detecting fallen pins after ball impact. More specifically, the mechanism for detecting the fallen pins after ball impact includes a combination of a detector and a vision system (e.g., camera vision). For example, to detect if the string has been pulled/dragged in a way that accurately detects that a pin has fallen, a detector per string (e.g., machine pin-string sliding detection system) may monitor the rotation of a pulley system or a tension on a sting passing a threshold amount that is affected by the string movement (as shown in FIGS. 1A-1C) of every single pin. On the other hand, the vision system has a view of the pins in which it can visually detect of a pin has fallen. (as shown in FIGS. 1A-4).

After intensive study and analysis of the two solutions, it has been surprisingly found that by combining the two systems (e.g., vision system and machine pin-string sliding detection system, e.g., encoders) into a tandem hybrid system, it is now possible to leverage the innate strength of each system, and creating a more accurate system then either system could in singular form. By combining the vision system and the system that detects the sliding or movement of the pin-string associated with each particular pin (e.g., machine pin-string sliding detection system (e.g., sensor or encoder)), it has now unexpectedly been found to be possible to more accurately determine which pin(s) have fallen after a throw of the bowling ball.

FIGS. 1A-1C show a pinspotter machine with a hybrid pin fall detection system in accordance with aspects of the present disclosure. More particularly, FIGS. 1A-1C show a pinspotter machine 100 with separate strings 3 used for each pin 2 such that the movement of the string 3, e.g., tension on the string, pull on the string, can be used to detect that the pin 2 associated with that string 3 has fallen. For example, in the pinspotter machine 100 of FIGS. 1A-1C, a plurality of pins 2 are positionable at predetermined points on the bowling lane 1 (at one end of the bowling lane 1). A plurality of strings 3 are provided at one end of each corresponding pin 2. In FIG. 1A, the pins 2 are in a raised position; whereas in FIG. 1B, the pins 2 are shown in a lowered position on the bowling lane 1. In FIG. 1C, the pins 2 are shown to be in a fallen position after a ball strike with the strings 2. In this case, the pins 2 can be detected to be in the fallen position by use of the hybrid pin fall detection system as described in more detail herein, e.g., the tension of the string or rotation of a pulley system passing a given threshold.

The pinspotter machine 100 also includes pulley system 5 provided for the raising and lowering the pins 2 by way of the strings 3 as is known in the art. For example, the pulley system 5 may move the pins 2 into different positions as shown in FIGS. 1A and 1B, e.g.:
1. a first position, allowing the pins 2 to be lifted from the bowling lane 1 (see FIG. 1A), and
2. a second position, allowing not only the pins 2 to be lowered onto the bowling lane 1 into the predetermined position but also each string 3 to be slackened by the release of a further first working length of it.
3. Another position after the pins 2 have been struck by a bowling ball such that the pins 2 fall freely when struck by a bowling ball thrown along the lane 1 or by other pins struck by the ball during play (for example, see FIG. 1C).

The pinspotter machine 100 further includes a control system 8 for controlling the position of the length of string managed by the pulley system 5, in addition to the determination of which pins 2 have fallen as detected by a machine pin-string sliding detection system 50 and a vision system 55 (camera or other vision system such as radar, LiDAR, etc. which hereinafter is referred generically as a vision system). The control system 8 may also incorporate or have a separate control, drive and selection system configured to move the pins into different operating system. For example, see U.S. Applicant Ser. No. 18/212,267, filed on Jun. 21, 2023, which is incorporated by reference in its entirety herein. It should be understood, though, that the hybrid pin fall detection mechanism for detecting fallen pins after ball impact of the present disclosure can be implemented in other pinspotter string bowling systems and, as such, the particulars described herein of a pinspotter string bowling system should not be considered a limiting feature.

As further shown in FIGS. 1A-1C, the detector per string (e.g., machine pin-string sliding detection system) 50 and the vision system 55 can be used to determine if a pin 2 has fallen. In embodiments, the machine pin-string sliding detection system 50 may be a machine string sliding detection system such as an encoder or other known system. In the encoder system, for example, the encoder may monitor the rotation of a pulley system to determine that a pin has fallen. The machine pin-string sliding detection system 50 may also be a string tension monitoring system, e.g., strain gauge, such that upon the string 3 being under a certain tension, e.g., passing a threshold amount that of tension as affected by the string movement, it can be determined that the pin 2 has fallen after a bowling ball strike or another pin striking the fallen pin.

In embodiments, the machine pin-string sliding detection system 50 may monitor each pin's string 3 to determine if it has been pulled/dragged by the falling pin. For example, with respect to the machine pin-string sliding detection system 50, with the assumption that if a string has moved/shifted/pulled/dragged from the position it had at the end of the spotting of the pin, in a way that is assumed to be caused to a fallen pin, then the pin can be initially detected as fallen. On the other hand, if a string movement/shift/pull/drag is not detected at all or is detected but does not pass a given threshold, the machine pin-string sliding detection system 50 can detect the pin as standing. This threshold may be a tension on the string, a movement of the pin or a certain rotation of the pulley system as examples.

The machine pin-string sliding detection system 50 is used in conjunction with the vision system 55 to establish if a pin 2 has fallen or is still standing by monitoring what happens to the pins 2, themselves. So, unlike the machine pin-string sliding detection system 50, the vision system 55 can look at the pins 2 to establish, through an image analysis, if the pins 2 have fallen or are standing.

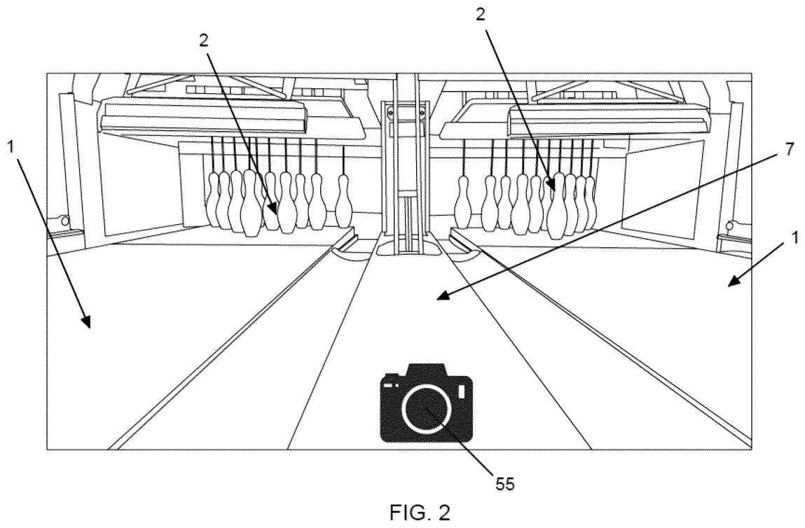

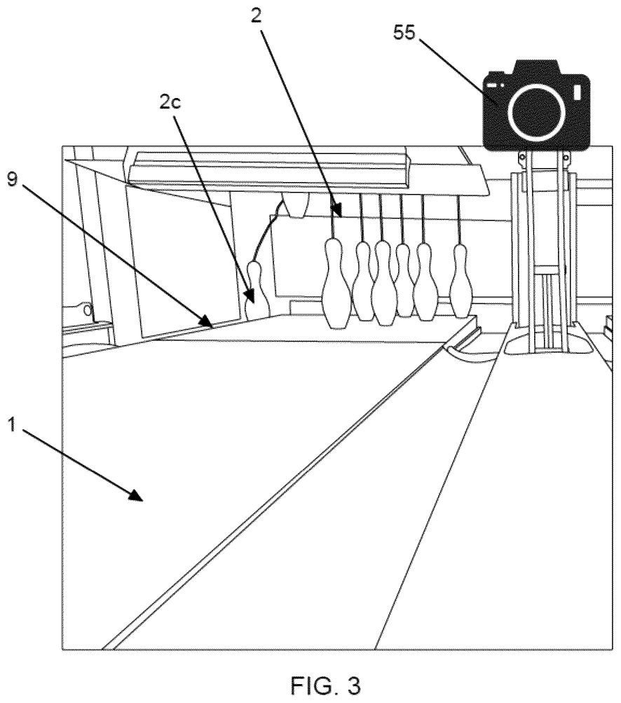

The vision system 55 can be selected considering several constraints, including having a good viewpoint (unimpeded to each of the pins 2) but also being protected from the hard impact of a ball/flying pins. For this reason, in general, the selected vision system location is between two lanes 1 of the pair (bowling lanes 1 are typically grouped in pairs), on the “ball return” capping 7, away from the ball/pin-action area as shown representatively in FIG. 2. For example, as shown in FIG. 2, the vision system 55 is placed between the bowling lanes 1 with all pins 2 in their initial position. More specifically, in FIG. 2, the position of the vision system 55 is chosen to allow the vision system 55 to see the pins 2 on both bowling lanes 1, where the position of the vision system 55 makes it possible for the vision system 55 to “see” all 10 pins.

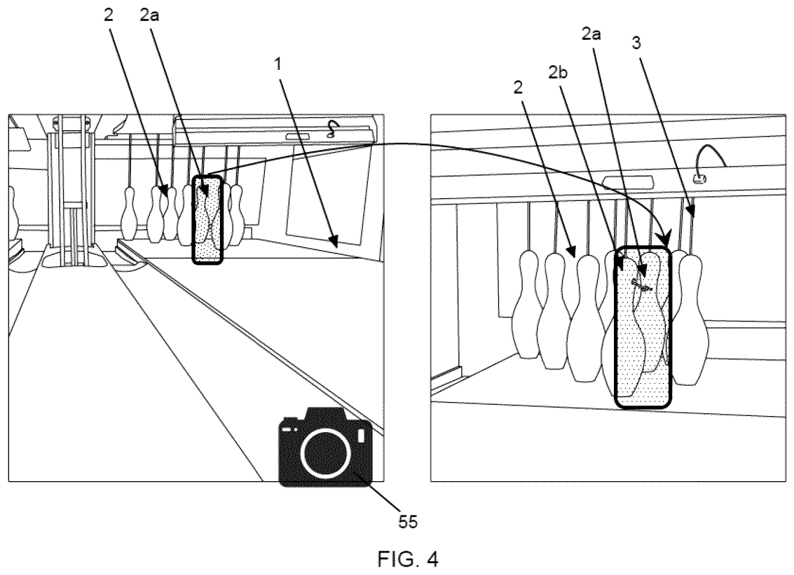

In embodiments, more than one vision system 55 may be contemplated by the present invention. For example, two or more vision systems 55 can be used at different locations including, for example, above the pins in the pin deck, etc., as shown representative in FIG. 3. (FIG. 3 can also represent a case where the vision system 55 reports a correct scoring while the string machine pin-string sliding detection system 50 reports a mistake due to “pin #7” not fallen but is out of the bowling lane 1 (so it would be considered fallen. In addition to or alternative, the vision systems 55 could be located closer to the pins 2 and dedicated to a single bowling lane 1 so that the number of vision systems 55 could be at least two. The use of one or more vision systems 55 does not affect or change the overall innovation described herein.

By using both the vision system 55 and the machine pin-string sliding detection system 50, the shortcomings of each system can now be avoided and an accurate detection of the pins falling after a ball strike can now be determined/detected with great confidence. For example, the use of the machine pin-string sliding detection system 50 can be used to detect:
1. A pin 2a hiding behind another pin 2b, which makes it difficult for the vision system 55 to determine if the pin 2a is standing or fallen as shown in FIG. 4. For example, it would be difficult to detect with the vision system 55 when a pin 2a ends up in a position hiding due to another falling pin or a standing pin 2b that has shifted the pin 2a behind another pin 2b. In this case, the machine pin-string sliding detection system 50 reports a correct scoring while the vision system 55 would report a mistake because pin 2a (pin 10) has not fallen but is just slightly moved left from the initial location. So, while the visions system 55 cannot detect pin 10 because “pin #10” is under the line of sight of the vision system 55, it is possible for the machine pin-string sliding detection system 50 to detect the fallen/standing pins; or
2. The pin's illumination might be very variable and is affected by other environment illumination, spotlights, flashes/strobe lights located somewhere in the bowling center for entertaining the customers, which would interfere with the imaging system of the vision system 55; whereas the machine pin-string sliding detection system 50 would be able to still detect the fallen/standing pins.

On the other hand, by using the vision system 55 it is now possible to detect the position of the pins 2 when the machine pin-string sliding detection system 50 is incapable of such detection. For example, the vision system 55 can be used in the following scenarios:
1. If, after the ball impact, the dynamic of the falling pins 2 ends up pushing another standing pin on the flat gutter (the gutter that is on the side of the pin deck), not making it fall and in which the string 3 has not been pulled enough to pass the threshold that makes the machine pin-string sliding detection system 50 detect that a pin has fallen, the vision system 55 can be used to determine that the pin 2c is standing in the gutter 9 or off the bowling lane 1 (as shown in FIG. 3) and, according to the rules the pin 2c has fallen; or
2. If the ball impact makes a pin flying above other pins and pulls their string above the threshold of the machine pin-string sliding detection system 50 but it is still standing, the vision system 55 can be used to determine that the pin is standing; or
3. As representatively shown in FIG. 3, the vision system 55 reports a correct scoring while the machine pin-string sliding detection system 50 reports a mistake due to pin 2c not fallen but is out of the bowling lane 1 (so it would be considered fallen). The string machine does not detect a fallen pin, while the camera can easily detect that pin 7 is out the bowling lane 1.

Accordingly, an implementation of the present invention uses a “combination matrix” feed by the vision system 55 (e.g., camera pin fall detection) and the machine string sliding detection system 50. That is, the present invention can use information from both the vision system 55 and machine pin-string sliding detection system 50 to provide a more accurate pin fall detection system.

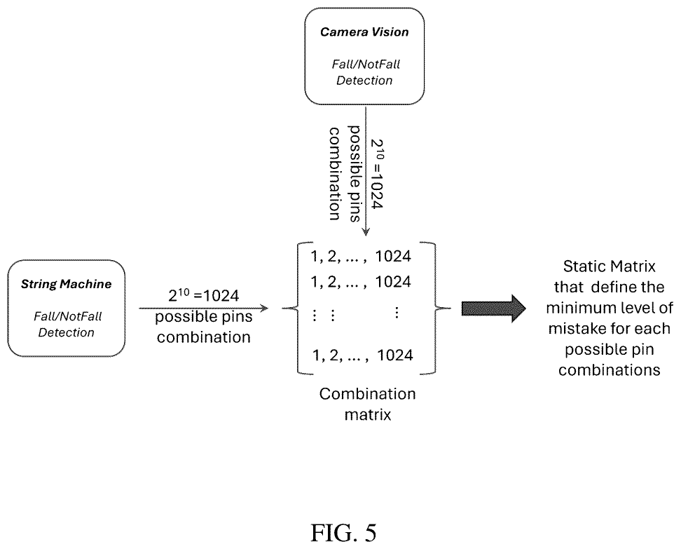

In embodiments, a combination matrix can be set based on statistical information and encoder/camera/misdetection statistical analysis. The quality of the combination matrix affects the accuracy of the resulting scoring detection. FIG. 5 shows an example computation algorithm that combines information from the machine pin-string sliding detection system 50 and the information from the vision system 55, to minimize the scoring mistakes in accordance with aspects of the present disclosure.

For example, in accordance with aspects of the present invention, the use of the vision system 55 and machine string sliding detection system 50 such as, for a non-limiting example, an encoder to detect the movement of the string passing a certain threshold may be used for populating the correlation matrix in the following processes:
1. Collect Data: Having a bowling center set up to gather information about pin-fall detection for the same ball from both a machine pin-string sliding detection system 50 and the vision system 55. Each of the two sources would provide the pin-fall detected. This information can also be used to train an artificial intelligence system as described herein.
2. Identify Mismatches: Compare the pin-fall from the two sources to identify discrepancies between them. For example, the visions system 55 may detect a pinfall, whereas the machine pin-string sliding detection system 50 may not. This information can then be correlated to show any discrepancies.
3. Human Review: For mismatched events, e.g., discrepancies in pinfall detection, a person can review a video clip of the event and provide the correct pin-fall count. This information can also be used in an artificial intelligence system, as well as correcting the discrepancy of the pinfall to update the matrix.
4. Determine a better result for any given situation: Analyze the review results to decide the correct pin-fall for every given combination.

In one example, based on 10,000 bowled balls, the below was built based on the processes described herein. This matrix, e.g., table below, show the performance on 10,000 balls bowled comparing misread performed by the vision system 55, misread made by the encoder, e.g., machine pin-string sliding detection system, and “resulting-misread” after the application of the correlation-matrix. In embodiments, the correlation matrix is a first implementation and can be evolved with further check and analysis as well as using the outcome of an artificial intelligence (AI) trained system as described herein.
# of vision system errors: 26
# of encoder errors: 62
# of errors by the matrix: 16

During verifications, other information might be used to feed the correlation matrix. An example is the ball speed or other factors such as weight of the ball, type of flooring used (natural wood vs. laminate) and type and weight of pins (if they are not regulation pins), string tension, string sway, ball trajectory, pin trajectory, etc. For example, a faster ball makes more likely to have flying pins, as does a heavier ball or lighter weight pins. So, the speed or other factors can be taken into account. Also, other machine configurations, like the string length attached to each pin, may also affect the performance of the machine pin-string sliding detection system 50 (e.g., encoder) and, hence, may be taken into account. These factors can be used to replace, or use in combination, the combination matrix with artificial intelligence (AI) trained to decide every time a mismatch is detected and, in embodiments, to accurately determine when a pin has fallen by analyzing data based on the vision system 55, machine pin-string sliding detection system 50 and any of the other factors, in which the AI was trained on.

It is interesting to note that gathering the score correction information entered by the bowler on the bowling lane 1 (who has witnessed what has happened and is applying scoring changes to the recorded score) can also be collected in association with the machine pin-string sliding detection system 50 and vision system 55, speed and other information and used to automatically train the AI so that the AI performance improves over time. This would allow the AI to be trained based on an automated gathering system that includes many different variables, as described herein.

Since most bowling centers are connected to centralized cloud management, it is possible to train the AI using the big data collection coming from other bowling centers. So, the AI can be trained using both local data coming from a specific bowling installation and a huge amount of shared information across all the bowling installations.

The pin-fall resulting after the correction mechanism (correlation matrix or other matrix) has been applied can then be used by both the machine (e.g., pinspotter system 100) and a scoring system:
1. The pinspotter machine 100 can use the information to manage its operations, basing the next steps on the “corrected” pinfall count, i.e. the machine can re-spot the still-standing pins for allowing the 2nd ball of the bowling frame to be bowled (this is the standard 10-pin bowling rule based on 2 balls per frame: if the 1st ball of the frame has not fallen all pins (strike) then the still standing pin are made available for a 2nd try for the bowler); and
2. The scoring system can use the information for calculating the score for each bowled ball.

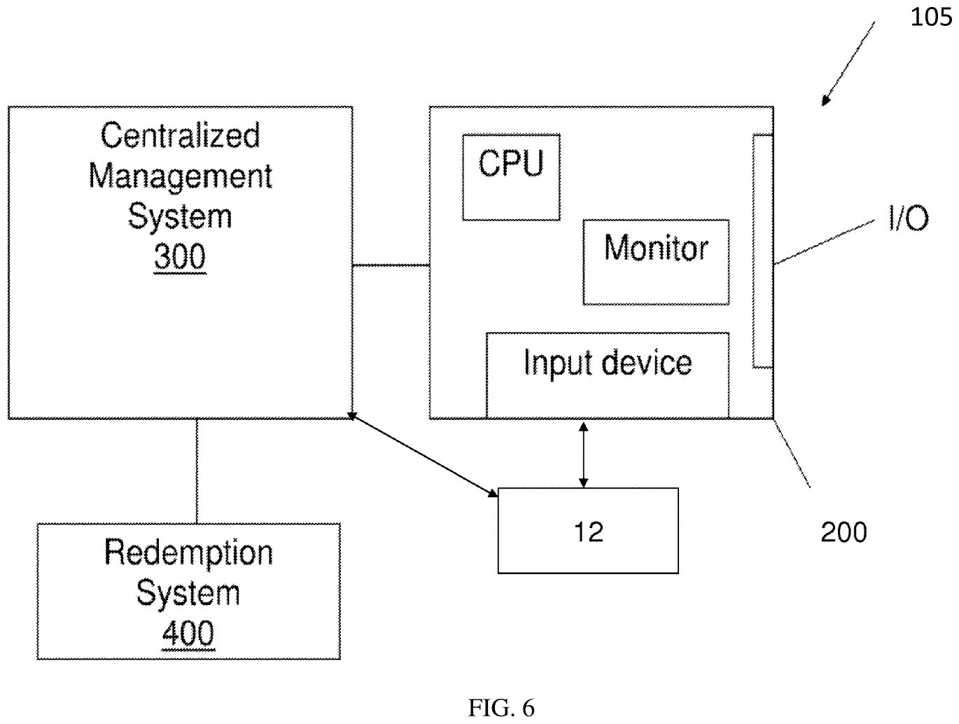

As shown in FIG. 6, in embodiments, the bowling center will include a bowling scoring and management system 105. The bowling scoring and management system 100 comprises, for example, the following features:
1. “Lane-Score-Computer” 200: The Lane-Score-Computer 200 is a computerized system that manages games on a bowling lane 1 or multiple bowling lanes 1. The example described herein assumes one pair of lanes; although the present invention also contemplates other configurations. In embodiments, the scoring system need not be present and, instead, a dedicated system for its own operations can be used to provide the “corrected” pin fall. In embodiments, the scoring system or in the case of a dedicated system includes a main CPU that is connected to:
(i) A local monitor (typically overhead display monitor above the bowling lane 1). In general, the monitors two may be used per pair (e.g., one per bowling lane 1);
(ii) I/O devices to interface with the pin detection system. This I/O device may also allow a user to manually enter or revise a score, including the number of pins that have fallen (and possibly even the actual pins that have fallen). This information may be used to further train the AI system or used in the matrix described herein, in combination with the vision system 55 and machine pin-string sliding detection system 50;
(iii) I/O devices to collect information regarding when a ball is thrown, how many pins have fallen, if a foul has been detected, and other information available on the bowling lane 1 about the ball that was bowled. These I/O devices to collect information regarding when a ball is thrown may interact, for example, with the vision system 55 and machine pin-string sliding detection system 50, in addition to the I/O devices to interface with the pin detection system; and
(iv) I/O console device (keypad, LCD, or similar) to allow the scoring system to interact locally on the bowling lane 1 with the bowlers. This I/O console device may allow a bowler to manually enter or revise a score, including the number of pins that have fallen (and possibly even the actual pins that have fallen). This information may be used to further train the AI system or used in the matrix described herein, in combination with the vision system 55 and machine pin-string sliding detection system 50.

In embodiments, the centralized management system 300 is a computerized system comprising one or more computers located at the counters and back office of the bowling center. This system allows the manager/employees of the bowling center to manage the customers from check-in to check-out. One of the functions performed by the management system is to send the necessary information to set up the Lane-Score-Computer, which then takes care of the game being bowled on the bowling lane 1. At the end of the game, the management system collects the necessary information from the Lane-Score-Computer to manage the game scores, rankings, payments, etc. The centralized management system 300 can control/manage any of the features of the present invention, including determining which pins have fallen based on the vision system 55, machine pin-string sliding detection system 50, and other factors described herein. The “Centralized Management System” 300 may also include the AI, which is trained using the vision system 55 and machine pin-string sliding detection system 50 and other factors described herein, in addition to determining which pins have fallen when a bowling ball strikes the pin set area and, more particularly, the pins. This may be determined using the statistical analysis or AI as described herein. The centralized management system can also be on the internet and in general able to consolidate the bowled ball information to make the AI be trained by a larger number of bowled balls.

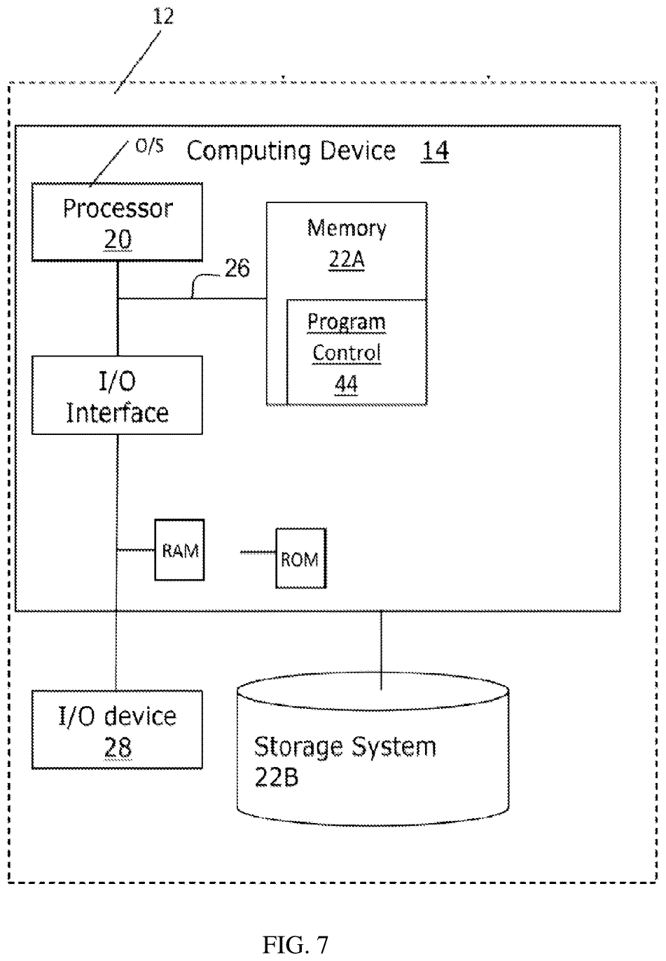

FIG. 7 shows a representative computer infrastructure, which can be representative of a bowling scoring and/or management system. Illustratively, the computer infrastructure can be representative of either the Lane-Score-Computer 200 or centralized management system 300. To this extent, the computer infrastructure includes a server or other computing system 12 that can perform the processes described herein, including those of the graphic content processing system (which is represented as reference number 12 in both FIGS. 6 and 7) and which has a bidirectional communication with a management system 300 and scoring system 200. In particular, the server 12 includes a computing device 14. The server 12 and/or computing device 14 can communicate over any communication link such as an intranet, LAN, WAN, Internet, etc. The computing device 14 can be a resident on a network infrastructure or a third-party service provider's computing device.

The computing device 14 also includes a processor 20, memory 22A, an I/O interface 24, and a bus 26. In addition, the computing device includes random access memory (RAM), read-only memory (ROM), and an operating system (O/S). The computing device 14 is in communication with the external I/O device/resource 28 and the storage system 22B. The I/O device 28 can comprise any device that enables an individual to interact with the computing device 14 (e.g., user interface) or any device that enables the computing device 14 to communicate with one or more other computing devices using any type of communications link.

The external I/O device/resource 28 may be, for example, a handheld device, tablet, smartphone, PDA, handset, keyboard, a system converting sounds into electrical signals sent to the scoring or management system and generating a relevant event used to trigger a special effect, etc.

In general, the processor 20 executes computer program code (e.g., program control 44), which can be stored in memory 22A and/or storage system 22B. The program control 44 provides the processes described herein. The program control 44 can be implemented as one or more program codes stored in memory 22A as separate or combined modules. Additionally, the program control 44 may be implemented as separate dedicated processors or a single or several processors to provide the function of these tools. While executing the computer program code, the processor 20 can read and/or write data to/from memory 22A, storage system 22B, and/or I/O interface 24. The bus 26 provides a communications link between each component in the computing device 14.

As will be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects. Furthermore, aspects of the present invention may take the form of a computer program product embodied in one or more computer readable medium(s) having computer readable program code embodied thereon. Any combination of one or more computer readable medium(s) may be utilized. The computer readable medium is not a signal per se and, instead, is a physical object such as computer readable medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

In embodiments, the AI can be trained using Machine Learning (ML). The ML includes the development of algorithms and statistical models that computer systems use to perform the complex tasks of detecting accurately which pins have fallen without explicit instructions. The ML will rely on patterns and inference based on the training data including information received from the vision system 55 pin-fall detection, machine pin-string sliding detection system and, in embodiments, the other factors, to train AI on and, which, then the AI can accurately determine with future ball throws which pins have fallen. In this way, the computer system uses ML algorithms to process quantities of historical data and identify data patterns of the pin falls based on the detection by the vision system 55, machine pin-string sliding detection system, and, in embodiments, use of the other information. The ML can use the dataset of several hundred or thousand data points, as described herein, for training, plus sufficient computational power to run. In further embodiments, ML can identify the patterns in large sets of data to solve specific problems, i.e., detection of which pins have fallen based on information received from the vision system 55, machine pin-string sliding detection system 50, the type of ball used, the speed of the ball, the trajectory of the pins, the weight of the pins, the length of the string, the slack in the string, etc.

Although scoring is merely one example of implementation, the present invention can be a standalone application in which the combination of vision system 55 and the machine pin-string sliding detection system can be used to determine accurately which pins have fallen. In addition, the scoring system can also be implemented in a different way where the scoring is not relevant to the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A pin fall detection system comprising:
a vision system positioned to detect a fallen pin; and
a machine pin-string sliding detection system to detect movement of individual strings attached to individual pins and which is used in tandem with the vision system to accurately determine which pins of the individual pins have fallen after a throw of a bowling ball.

2. The pin fall detection system of claim 1, further comprising a computing system which receives data from the vision system and the machine-pin sliding detection system to determine which of the individual pins have fallen based on the data.

3. The pin fall detection system of claim 2, wherein the computing system uses a correlation matrix feed by the vision system and the machine string sliding detection system to determine which of the individual pins have fallen.

4. The pin fall detection system of claim 3, wherein the correlation matrix is set based on an encoder, the vision system and misdetection statistical analysis.

5. The pin fall detection system of claim 3, wherein the machine-pin sliding detection system determines movement of the string passing a certain threshold which is used for populating the correlation matrix.

6. The pin fall detection system of claim 3, wherein the machine-pin sliding detection system determines movement of a pulley system of a pinspotter machine passing a certain threshold which is used for populating the correlation matrix.

7. The pin fall detection system of claim 2, wherein the computing system collects data from both the machine pin-string sliding detection system and the vision system, identifies mismatches which are indicative of discrepancies between the machine pin-string sliding detection system and the vision system and analyzes the results to decide a correct pin-fall for every given combination.

8. The pin fall detection system of claim 7, wherein the computing system creates a correlation-matrix based on comparing misread performed by the vision system and the machine pin-string sliding detection system.

9. The pin fall detection system of claim 8, wherein additional information is fed to the correlation matrix, wherein the additional information comprises at least one of weight of the bowling ball, type of flooring used in a bowling lane, type and weight of the individual pins, string tension, string sway, ball trajectory, or pin trajectory.

10. The pin fall detection system of claim 9, wherein the misreads of the vision system and the machine pin-string sliding detection system and, optionally, the additional information are used with artificial intelligence (AI) for training to decide every time a mismatch is detected and to accurately determine when a pin has fallen.

11. The pin fall detection system of claim 10, wherein the AI is trained on data from different bowling centers.

12. The pin fall detection system of claim 1, wherein the vision system comprises a camera vision system.

13. A system comprising:
a vision system positioned to view a plurality of pins at an end of a bowling lane;
a machine pin-string sliding detection system configured to detect movement of individual strings attached to individual pins; and
a control system that is in communication with the vision system and the machine pin-string sliding detection system, the control system receiving data from the vision system and the machine pin-string sliding detection system as to which pins of the plurality of pins each of the vision system and the machine pin-string sliding detection system have detected to be fallen and which reconciles the data to determine which pins have fallen.

14. The system of claim 13, wherein the control system uses a correlation matrix populated by the vision system and the machine string sliding detection system to determine which of the individual pins have fallen.

15. The system of claim 14, wherein the correlation matrix is set based a misdetection statistical analysis.

16. The system of claim 14, wherein the machine-pin sliding detection system determines movement of the string passing or movement of a pulley system of a pinspotter machine a certain threshold which is used for populating the correlation matrix.

17. The system of claim 13, wherein the control system, identifies mismatches from both the machine pin-string sliding detection system and the vision system which are indicative of discrepancies between the machine pin-string sliding detection system and the vision system and analyzes the results to decide a correct pin-fall for every given combination.

18. The system of claim 17, wherein the computing system creates a correlation-matrix based on comparing misread performed by the vision system and the machine pin-string sliding detection system.

19. The system of claim 13, wherein misreads of the vision system and the machine pin-string sliding detection system are used with artificial intelligence (AI) for training to decide every time a mismatch is detected and to accurately determine when a pin has fallen.

20. The system of claim 13, wherein the vision system comprises a camera vision system.
